(19) United States
(12) Patent Application Publication
(10) Pub. No.: US 2022/0253801 A1
(43) Pub. Date: Aug. 11, 2022

(54) PIECE VERSUS MULTI-PIECE CARRIER OPTIMIZATION

(71) Applicant: Walmart Apollo, LLC, Bentonville, AR (US)

(72) Inventors: Ashutosh Prakash Mishra, Varthur (IN); Manohar Reddy Vummadi, Bangalore (IN); Aishwarya Manjunath, Bangalore (IN); Ehsanallah Naseri, Vaughan (CA); Iqra Haseeb, Mississauga (CA); Tanuj Deshpande, Bangalore (IN)

(21) Appl. No.: 17/589,990

(22) Filed: Feb. 1, 2022

(30) Foreign Application Priority Data
Feb. 8, 2021 (CA) 3108406

(51) Int. Cl. G06Q 10/08; B65B 5/04; B65B 5/06

(52) U.S. Cl. CPC G06Q 10/08345; B65B 5/06; B65B 5/04; G06Q 10/08355

(57) ABSTRACT

Examples provide a system and method for optimizing single piece versus multi-piece shipment for source-carrier combinations. A manager component calculates an estimated shipping cost for all possible combinations of source-carrier associated with delivery of items from the source to a destination. The system iteratively calculates a cost for shipping the item with every combination of carriers and sources as a single piece only packaging, as well as a multi-piece packaging where applicable based on rate cards for the carriers. The combination of source-carrier and boxing method providing the lowest estimated shipping cost in a plurality of calculated shipping costs is selected for order fulfillment. The selected carrier is assigned to deliver the ordered items from the source location to the destination location. A notification can be sent to the user identifying the selected carrier and estimated date of delivery of the items.

### BACKGROUND

Traditionally, when a customer orders multiple items from a single seller, the seller attempts to consolidate the ordered items into a single box or other container for shipping to the customer. Where items are shipped in large trucks as freight or by air, consolidated packing reduces overall shipping costs. However, these large, consolidated packages sometimes require the use of specialized equipment or multiple people to carry or move the packages due to their increased weight. Moreover, carriers frequently now utilize a wide variety of smaller vehicles for deliveries rather than relying solely on large trucks. For example, carriers may utilize vans, cars, pickup trucks, and even two-wheeled vehicles for deliveries, as these smaller vehicles can be more cost effective. In such cases, these vehicles may be unable to accommodate large packages inside trunks and other smaller storage spaces.

### SUMMARY

Some examples provide a computer-implemented method for managing piece and multi-piece carriers for item shipment. Order data is received from a user device. The order data includes an identification of a set of items, a delivery destination, and a delivery time-period. A manager component analyzes a plurality of carrier rates obtained from a plurality of rate cards associated with a plurality of carriers available for delivery of the set of items from at least one source location to the delivery destination. The plurality of rate cards includes a set of single piece rate cards describing rates for shipping the set of items in a single container and a set of multi-piece rate cards describing rates for shipping the set of items in two or more separate containers. The manager component calculates a plurality of shipping cost values based on the plurality of carrier rates and item data associated with the set of items. The item data includes item weight and item dimensions for each item in the set of items. The manager component identifies a lowest shipping cost value in the plurality of shipping cost values. Each value in the plurality of shipping cost values corresponds to a calculated cost for shipping the set of items packaged according to a selected boxing method for delivery to the delivery destination from a selected source by a selected carrier in the plurality of carriers. The plurality of shipping cost values includes at least one shipping cost value for each carrier-source pair. The manager component selects a carrier from the plurality of carriers and the boxing method corresponding to the lowest shipping cost value in the plurality of shipping cost values. The boxing method specifying a number of containers into which the set of items are packaged for shipping. The boxing method is a single-piece boxing method or a multi-piece boxing method. The manager component provides a notification to the user device. The notification identifies the selected carrier and the number of containers selected to ship the set of items to the delivery destination within the delivery time-period.

Other examples provide a system for managing piece and multi-piece carriers for item shipment. The system includes a memory and at least one processor communicatively coupled to the memory. Order data, including an identification of a set of items, a delivery destination, and a delivery time-period, is received. A plurality of carrier rates are obtained from a plurality of rate cards associated with a plurality of carriers available for delivery of the set of items from at least one source location to the delivery destination are analyzed. The plurality of rate cards includes a set of single piece rate cards describing rates for shipping the set of items in a single container and a set of multi-piece rate cards describing rates for shipping the set of items in two or more separate containers. A plurality of shipping cost values are calculated based on the plurality of carrier rates and item data associated with the set of items. the item data includes item weight and item dimensions for each item in the set of items. Each value in the plurality of shipping cost values corresponding to a calculated cost for shipping the set of items packaged according to a selected boxing method for delivery to the delivery destination from a selected source by a selected carrier in the plurality of carriers. The plurality of shipping cost values includes at least one shipping cost value for each carrier-source pair. A carrier is selected from the plurality of carriers and the boxing method corresponding to a lowest shipping cost value in the plurality of shipping cost values. The boxing method specifies a number of containers into which the set of items are packaged for shipping. The boxing method includes a single-piece or a multi-piece boxing method. The selected carrier is assigned to transport the set of items from the selected source to the delivery destination.

Still other examples provide one or more computer storage media, having computer-executable instructions for managing piece and multi-piece carriers for item shipment that, when executed by a computer cause the computer to perform operations. The operations include obtaining a plurality of carrier rates from a plurality of rate cards associated with a plurality of carriers available for delivery of a set of items from at least one source location to a delivery destination. A plurality of shipping cost values are calculated based on the plurality of carrier rates and item data associated with the set of items. The lowest shipping cost value is identified. The carrier and boxing method associated with the lowest shipping cost value is selected for transport of the items.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for optimizing piece versus multipiece shipment (PVS) carrier management.

FIG. 2 is an exemplary block diagram illustrating source-carrier pairs for delivery of items to a destination.

FIG. 3 is an exemplary block diagram illustrating a system for optimizing PVS carriers.

FIG. 4 is an exemplary block diagram illustrating a manager component.

FIG. 5 is an exemplary block diagram illustrating PVS carriers.

FIG. 6 is an exemplary block diagram illustrating a box selection component for selecting a container for packaging an item for shipment.

FIG. 7 is an exemplary block diagram illustrating a carrier cost calculator.

FIG. 8 is an exemplary flow chart illustrating operation of the computing device to select a carrier and boxing method for shipping one or more items to a customer.

FIG. 9 is an exemplary flow chart illustrating operation of the computing device to optimize PVS carrier selection for shipping items from a source to a destination.

FIG. 10 is an exemplary flow chart illustrating operation of the computing device for determining whether to pack an item in a box or without a box.

FIG. 11 is an exemplary flow chart illustrating operation of the computing device to determine boxing for a hazmat item.

FIG. 12 is an exemplary flow chart illustrating operation of the computing device to determine boxing for a normal item.

FIG. 13 is an exemplary flow chart illustrating operation of the computing device for determining boxing for multiple items.

FIG. 14 is an exemplary flow chart illustrating operation of the computing device for packing bag and mailer items.

FIG. 15 is an exemplary flow chart illustrating operation of the computing device for multi-piece carrier item boxing.

FIG. 16 is an exemplary flow chart illustrating operation of the computing device to determine if a box is suitable for a given carrier.

FIG. 17 is an exemplary flow chart illustrating operation of the computing device to perform PVS optimization for single item solution (SIS).

FIG. 18 is an exemplary flow chart illustrating operation of the computing device to perform PVS optimization for multi-item solution.

FIG. 19 is an exemplary table illustrating large package surcharge data.

FIG. 20 is an exemplary block diagram illustrating a rate chart.

FIG. 21 is an exemplary block diagram illustrating a carrier logistic configuration rate card.

FIG. 22 is an exemplary block diagram illustrating a single-piece rate card.

FIG. 23 is an exemplary block diagram illustrating a multi-piece rate card.

FIG. 24 is an exemplary table illustrating shipping cost savings as a result of PVS optimization.

FIG. 25 is an exemplary cost calculation algorithm.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

For ecommerce users, it is desirable to optimize transportation cost incurred to deliver customer packages (items packaged in different sizes of boxes) by selecting the most affordable or least expensive carrier to deliver the packaged (boxed) items to a destination. The primary objective is to minimize the transportation cost while continuing to deliver package(s) as fast as possible.

The traditional approach has been to optimize transportation by reducing the number of boxes used to fulfill a shipment. In some examples, the general notion of packaging and delivering items is to pack the items of an order into a single box to decrease transportation and handling costs. However, that is not always the best way to optimize transportation and reduce shipping costs. There have been recent changes in the transportation industry with inclusion of crowd sourced delivery.

The last mile delivery is most expensive and time-consuming part of the transportation. Many carriers prefer to use small trucks for last mile delivery where packaging items efficiently into multiple smaller boxes provides a greater advantage as it allows for an easier way of handling multiple smaller packages compared to larger packages. For some of the carriers, it is more convenient to ship multiple small boxes as compared to one big box.

For this reason, some carriers have recently begun to offer two types of rate cards for calculating item shipping costs, a piece rate card and a multi-piece rate card. A piece rate card enables charging as per billable weight of each box. A multi-Piece Rate Card enables billing for aggregate billable weight of multiple boxes in a single shipment to a single destination. Also, given that carriers are not spending extra effort to deliver multiple packages to a single destination, it provides them with an opportunity to provide better rates to the customers to gain more business.

Carrier charges for shipping items are typically calculated based on combination of transportation distances, single or multiple destinations, size of packages handled, volume of packages handled and/or type of items handled. One of the recent trends has been charging clients based on charging overall packages to be delivered to a destination instead of charging for each individual package because carriers are not spending extra effort to deliver multiple packages to a single destination. This provides carriers with an opportunity to provide better rates to the customers to gain more business.

A piece versus multi-piece shipment (PVS) carrier rate card offering, including both single piece rate cards and multi-piece rate cards for carriers is valuable because e-commerce business generally deals with delivering shipments to the customer which might include multiple packages of varying dimensions and weights. Only considering single piece-based card or only utilizing multi-piece-based rate cards may not provide the optimal cost. Therefore, the manager component chooses the rate cards in a hybrid fashion followed by efficient box selection (boxing of items) and efficient carrier selection leading to optimizing the transportation cost. Controlling transportation costs ensures better margins are obtained on sales, this enables users to realize significant business value.

Some non-limiting examples of the disclosure enable a system to intelligently determine carrier selection which can deliver packaged(boxed) items to customer address(es) while minimizing the transportation cost and ensuring delivery occurs as fast as possible.

Referring to the figures, examples of the disclosure enable a system for optimizing piece versus multi-piece shipment carriers for delivering items from a source to a destination while minimizing the shipping costs. In some examples, a manager component calculates the shipping costs for all available carriers capable of delivering two or more items from a source to a destination within a selected delivery time-period using single piece packaging for both items and using multi-piece packaging of both items in a single box. In this manner, the system automatically calculates all possible rates/cost of shipping the item from any available source by any available carrier.

In other examples, the system identifies the lowest shipping cost value for shipping one or more items, whether by single piece carrier or multi-piece carrier. This enables the user to select the most affordable shipping method and the most cost-effective packaging method while ensuring timely delivery of the item.

In yet other examples, a carrier providing the lowest shipping rates for either piece or multi-piece packaging is selected to deliver a set of two or more items from a source to a destination within a selected delivery time-period. The system automatically identifies the optimized combination of source and carrier with boxing method that provides the lowest shipping costs to the user. This enables reduced shipping costs and increased speed of delivery for users.

With piece vs multi-piece carrier analysis, the system optimizes shipping to improve savings in the transportation cost incurred by users. The system enables configuration of piece and multi-piece carriers, which has the direct impact on the savings in the transportation cost. A cost-based boxing algorithm is utilized to optimize item packaging. In this manner, the system avoids accessorial charges which might be applicable. With PVS and optimized boxing, the system further saves money, lessens wastage of packaging material, and cuts down energy consumption of carriers to ship the boxes.

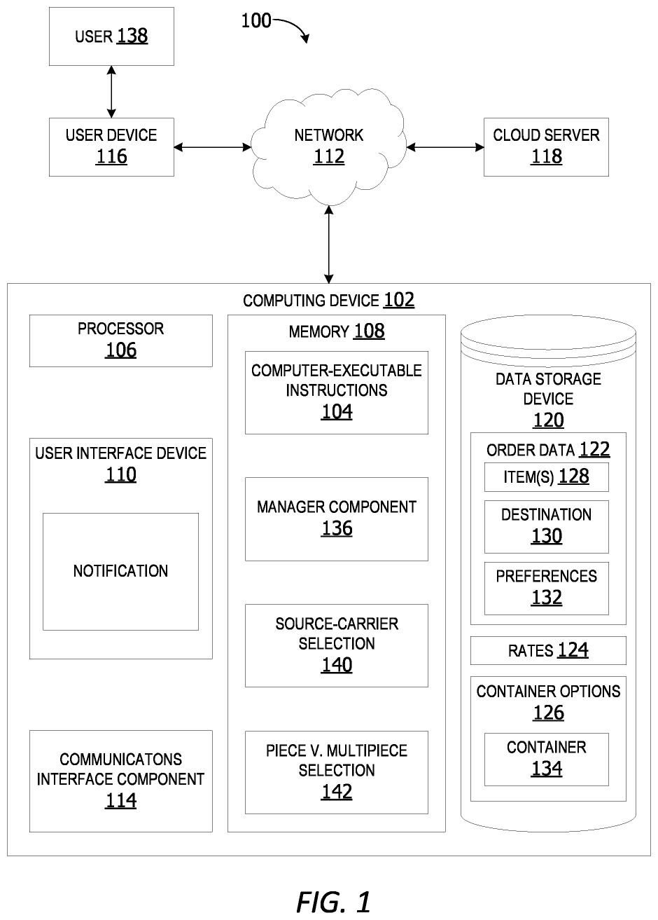

Referring again to FIG. 1, an exemplary block diagram illustrates a system 100 for optimizing piece versus multipiece shipment (PVS) carrier management. In the example of FIG. 1, the computing device 102 represents any device executing computer-executable instructions 104 (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, and/or portable media player.

The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102 in other examples includes a user interface component 110.

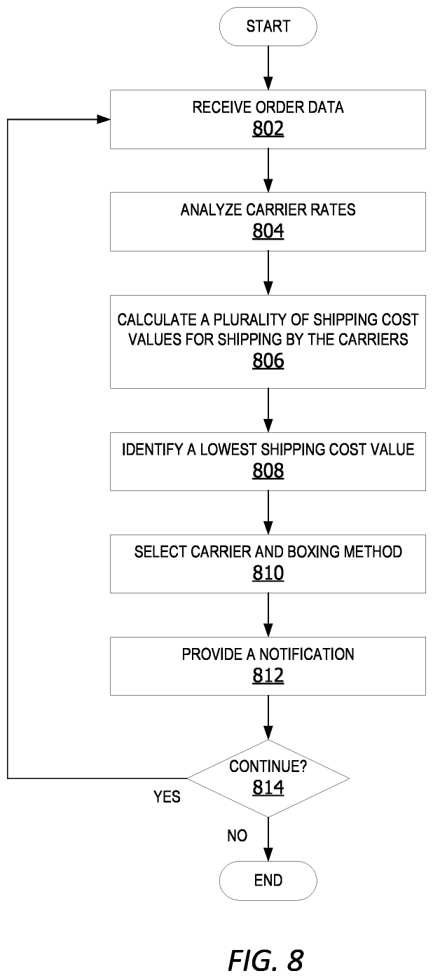

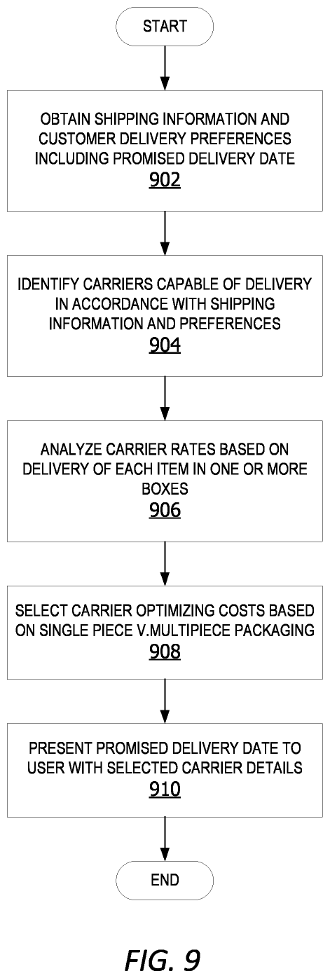

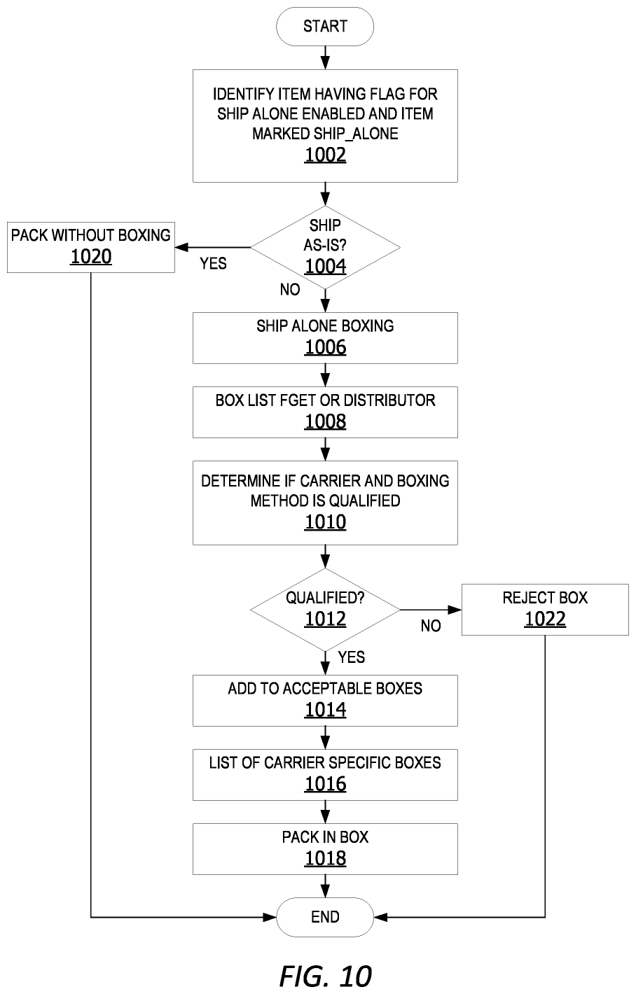

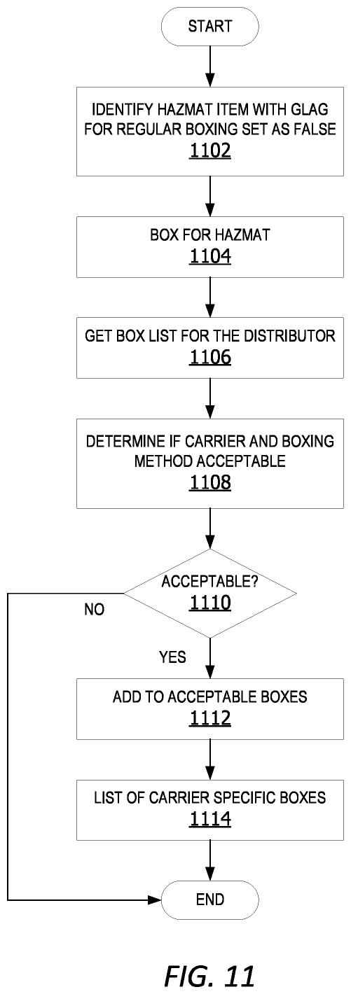

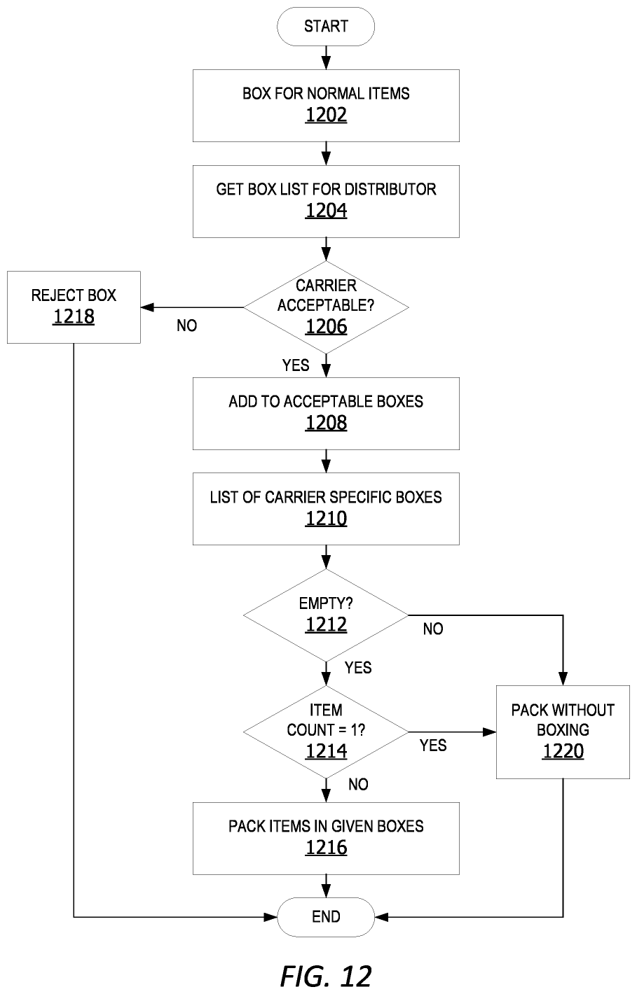

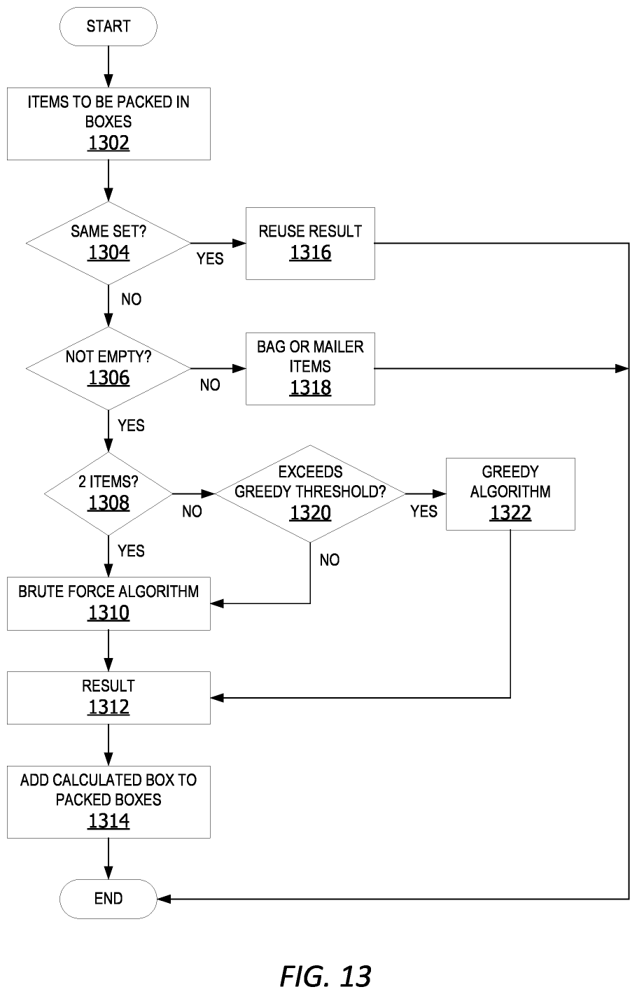

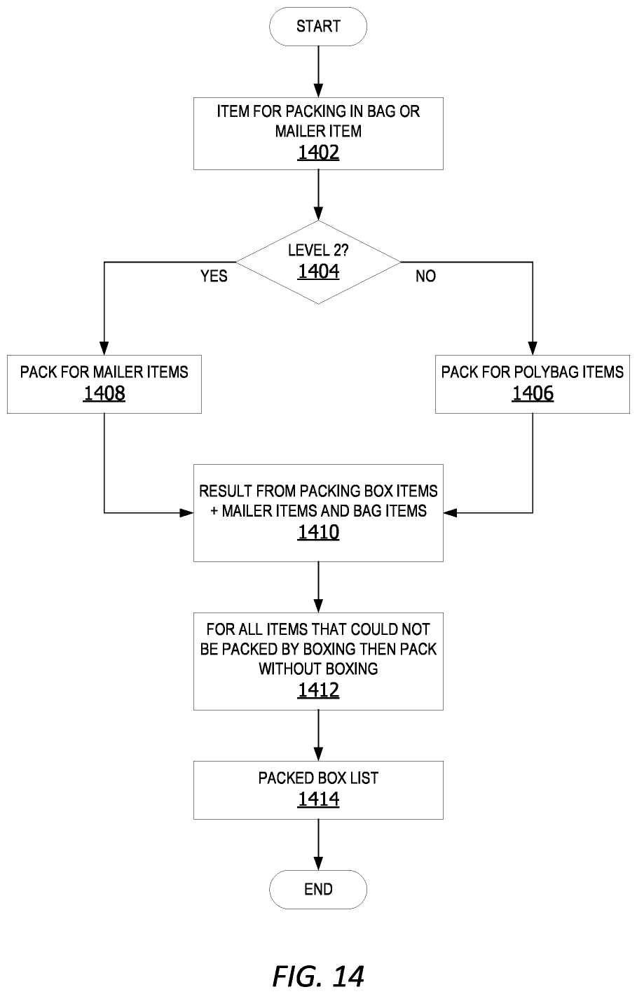

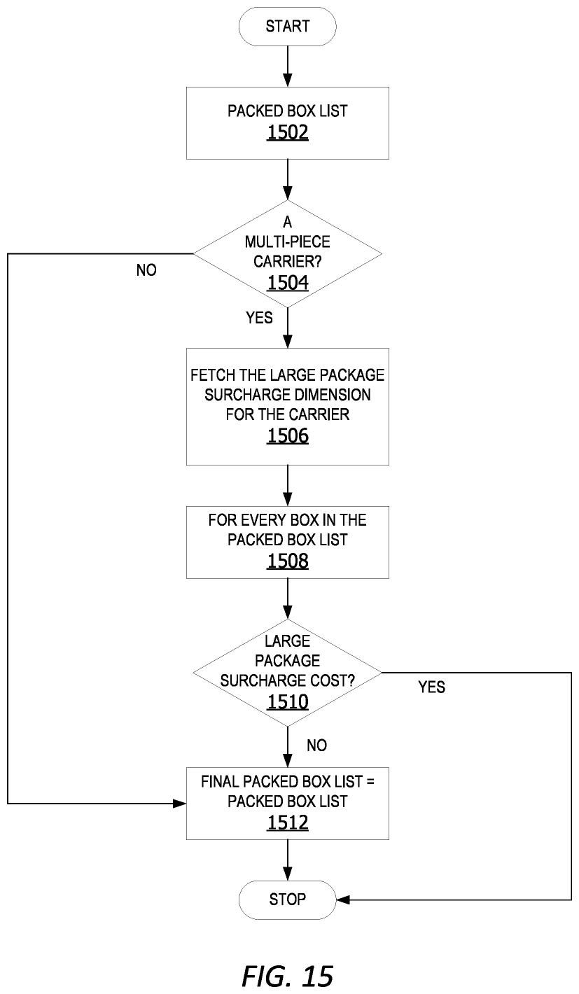

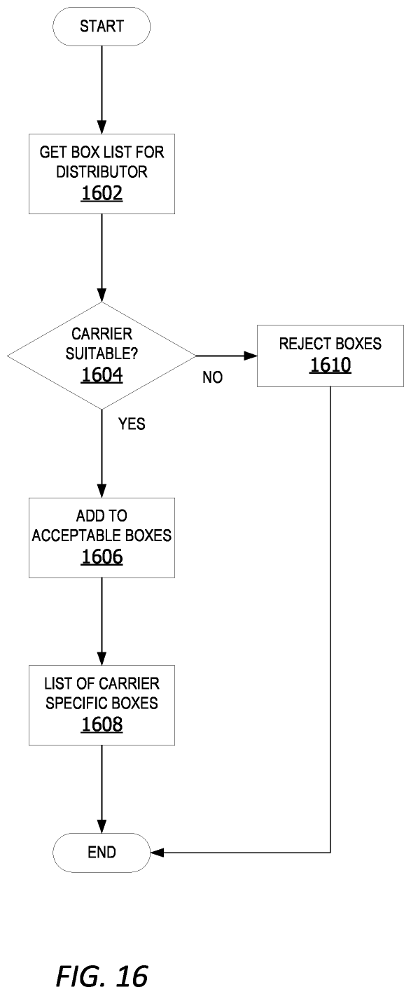

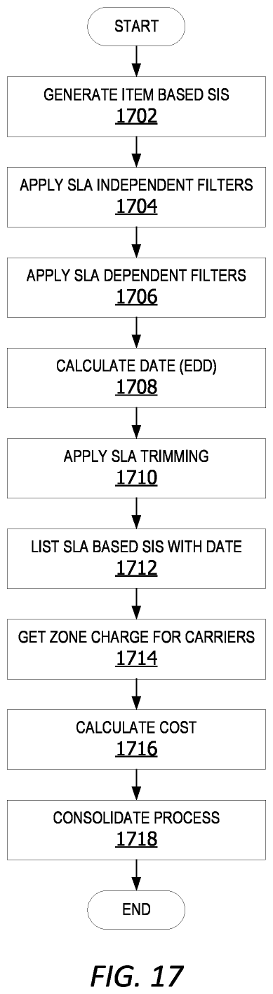

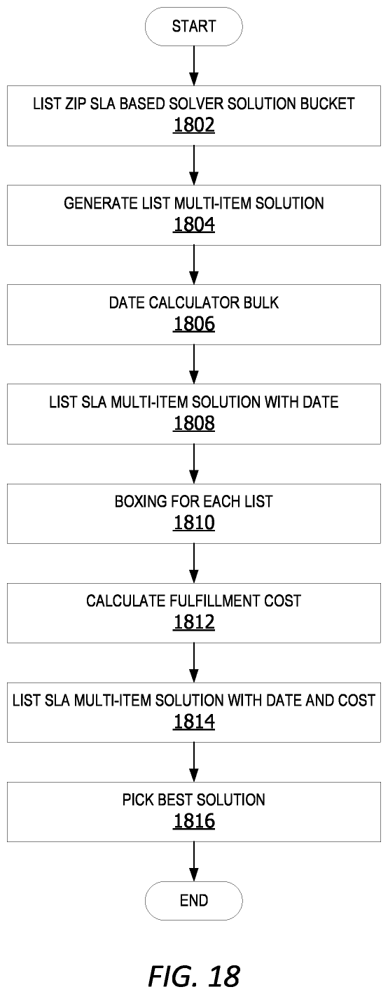

The processor 106 includes any quantity of processing units and is programmed to execute the computer-executable instructions 104. The computer-executable instructions 104 is performed by the processor 106, performed by multiple processors within the computing device 102 or performed by a processor external to the computing device 102. In some examples, the processor 106 is programmed to execute instructions such as those illustrated in the figures (e.g., FIG. 8, FIG. 9, FIG. 10, FIG. 11, FIG. 12, FIG. 13, FIG. 14, FIG. 15, FIG. 16, FIG. 17, and FIG. 18).

The computing device 102 further has one or more computer-readable media, such as the memory 108. The memory 108 includes any quantity of media associated with or accessible by the computing device 102. The memory 108, in these examples, is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface component 110 includes a graphics card for displaying data to the user and receiving data from the user. The user interface component 110 can also include computer-executable instructions (e.g., a driver) for operating the graphics card. Further, the user interface component 110 can include a display (e.g., a touch screen display or natural user interface) and/or computer-executable instructions (e.g., a driver) for operating the display. The user interface component 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface component 114. The communications interface component 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface component 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface component.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The system 100 can optionally include a data storage device 120 for storing data, such as, but not limited to order data 122, carrier rates 124 and/or container options 126. The order data 122 is data associated with an order to purchase one or more item(s) 128 created by a user, such as, but not limited to, via an e-commerce online order. The order data 122 includes data describing the item(s) 128, the destination 130 for the order and/or preferences 132. The preferences 132 are carrier preferences. In other examples, the preferences 132 can include preferences associated with a service level agreement with a customer.

The destination 130 is the delivery address. The delivery address can be a home (residence) address, a business address, a store address for later pickup, and/or the location of an order pickup kiosk. The preferences 132 are preferences for the order, such as, but not limited to, delivery time-period, sign on delivery (SOD) preferences, time of day for delivery, or any other preferences.

The preferences 132 reflect the services which are available from a particular carrier. For example, one carrier may be capable of providing SOD options while another carrier is unable to provide SOD services. In another example, one carrier may be willing to delivery packages on weekends while another carrier prefers not to provide delivery services on weekends. Thus, in these examples, the preferences 132 refers to carrier capabilities and services provided by each carrier.

The rates 124 includes one or more shipping rates for one or more packages by a selected carrier based on the size (dimensions) and weight of the package, type of item being shipped, destination 130, and/or any other variables influencing carrier rates.

The container options 126 are available options for boxing, bagging or otherwise packaging one or more ordered item(s) in a container for shipping. The container options 126 vary for each possible source because each source may have different containers available for boxing the items in preparation for shipping from the source. For example, a warehouse may have three different container (box) sizes available that would be suitable for packaging one or more ordered items. Another possible source which is able to provide the ordered items for pickup by a carrier may have four different container (box) sizes available in which the ordered item(s) can be boxed for shipping. The system employs a boxing algorithm to determine the optimized box size for each item based on the available box sizes at each source location.

A container 134 can include, without limitation, a box, bag, sack, wooden crate, plastic wrap, shipping crate, or any other type of packaging for shipping an item. A box can include a cardboard box, wooden box, plastic box, or any other type of box.

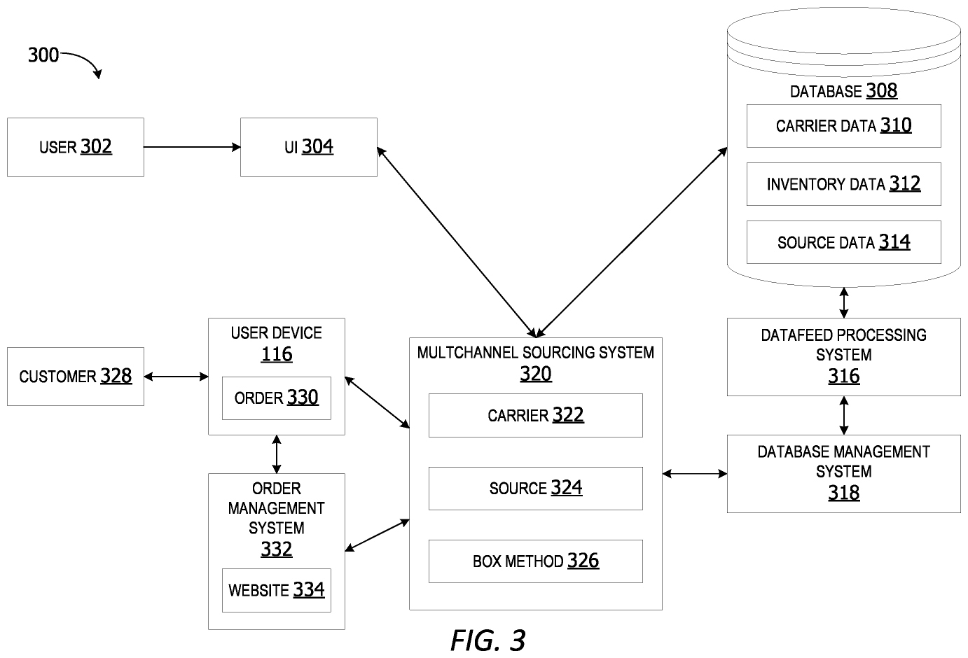

The data storage device 120 can include one or more different types of data storage devices, such as, for example, one or more rotating disks drives, one or more solid state drives (SSDs), and/or any other type of data storage device. The data storage device 120 in some non-limiting examples includes a redundant array of independent disks (RAID) array. In other examples, the data storage device 120 includes a database, such as, but not limited to, the database 308 in FIG. 3 below.

The data storage device 120 in this example is included within the computing device 102, attached to the computing device, plugged into the computing device, or otherwise associated with the computing device 102. In other examples, the data storage device 120 includes a remote data storage accessed by the computing device via the network 112, such as a remote data storage device, a data storage in a remote data center, or a cloud storage.

The manager component 136 is a software component stored on the memory 108 and executed by the processor 106. The manager component 136 receives the order data 122 from the user device 116 and/or an e-commerce website or other application via the network 112. The order data 122 identifies a set of one or more items 128, a delivery destination 130 for the ordered items, and/or preferences 132. The preferences can include a preferred delivery time-period, preferred delivery methods, and other user preferences. The manager component 136 obtains the carrier rates 124 for a plurality of carriers capable of delivering the item(s) to the user 138 at the destination 130 from at least one source location.

A source is a source of at least one item ordered by a user. A source can be implemented as, for example but without limitation, a distribution center (DC), warehouse, a store, a third-party provider, marketplace seller, or any other source of an item.

The rates 124 include single piece rates and multi-piece rates for delivering items. The rates 124 vary based on the weight of an item, dimensions of an item, delivery location, delivery distance, delivery dates, types of items, etc.

The manager component 136 calculates shipping cost values for every possible combination of item sources and carriers using single piece packaging and multi-piece packaging. Using the plurality of calculated cost values, the manager component 136 performs source-carrier selection 140 and piece v. multi-piece selection 142 to select a carrier and a boxing method.

In other examples, the manager component 136 provides a notification 144 to the user device identifying the selected carrier and the number of containers selected to ship the set of items to the delivery destination within the delivery time-period. The notification may be transmitted to the user device 116 via the network 112. The notification can be displayed on a user interface device of the user device 116.

In some examples, the notification 144 provides information associated with the source-carrier selection 140, the expected delivery date, and other order-related information associated with order fulfillment.

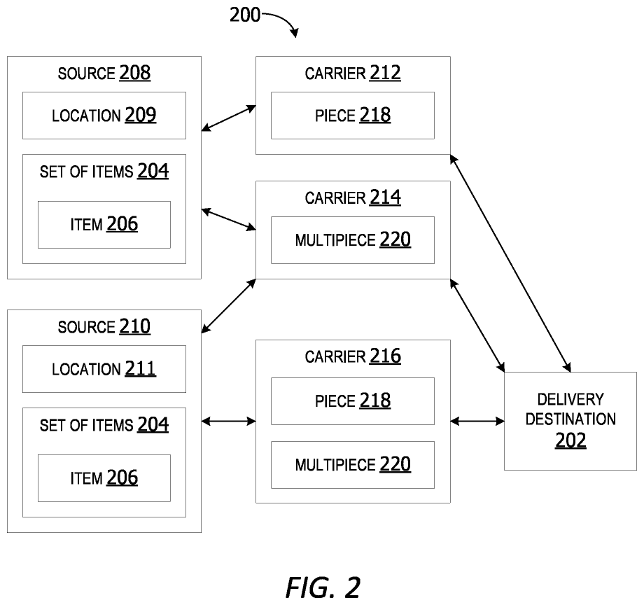

FIG. 2 is an exemplary block diagram illustrating a mapping 200 of source-carrier pairs for delivery of items to a destination 202. In some examples, a set of two or more items 204 is ordered by a user, such as, but not limited to, an item 206. The system identifies all sources which can provide the set of items 204 for delivery to the user. In this example, the available sources of the set of items 204 includes a source 208 at a first location 209 and a source 210 at a second location 211. The first location is a different location than the second location 211. The system maps each available carrier which is capable of picking the set of items up from each source and delivering the item(s) to the delivery destination 202.

In this non-limiting example, a carrier 212 maps to source 208, indicating that the carrier 212 can deliver the set of items 204 from the source 208 to the delivery destination 202. The carrier 214 maps to both the source 208 and the source 210. In other words, the carrier 214 can deliver the set of items 204 from the source 208 or the source 210. The carrier 216 can deliver items from the source 210.

The system identifies every possible source-carrier combination for delivery of the ordered items to the destination based on all possible sources and all possible carriers capable of performing the delivery in accordance with the order requirements and user preferences. In this example, there are three possible source-carrier combinations. A first combination is source 208 with carrier 212. A second possible source-carrier combination is source 208 and carrier 214. A third possible source-carrier combination in this example is source 210 and carrier 214. A fourth possible source-carrier combination is source 210 and carrier 216.

The system calculates shipping cost values for every combination of source-carrier and every boxing method available. The boxing method refers to single piece packaging in which two or more items are packaged in a single container or multi-piece packaging in which two or more items are packaged in two or more packages for shipping to minimize total billable weight of the containers in the shipment.

In this non-limiting example, the carrier 212 provides single piece 218 rate cards for shipping. The carrier 214 provides multi-piece rate cards for shipping. The carrier 216 provides both single piece 218 rate cards and multi-piece rate cards for shipping. In other words, the carrier 216 provides shipping options for both single piece and multi-piece shipping.

The system calculates the shipping cost for every possible combination of source-carrier and boxing method (piece or multi-piece). In this example, there are five possible combinations. The first combination is the piece rate for the source 208-carrier 212 combination. The second combination is the multi-piece 220 rate for the source 208-carrier 214. The third combination is the multi-piece rate for the source 210-carrier 214 combination. The fourth combination is piece 218 rate for the source 210-carrier 216 combination. The fifth combination is the multi-piece 220 rate for the source 210-carrier 216 combination. Thus, in this example, the system calculates five different shipping costs for shipping the set of items from a source to the destination.

The system automatically selects the source-carrier combination and boxing method associated with the lowest shipping cost estimate. If the lowest shipping cost estimate is associated with shipping the set of items from the source 210 via the carrier 214 using multi-piece boxing method, then the carrier 214 is selected to deliver the set of items from the source 210 to the delivery destination 202. The set of items are packages in two or more boxes at the source 210 for transit based on the size (dimensions) and weight of each item in the set of items, in accordance with a boxing algorithm, as discussed below.

In another example, if the lowest shipping cost is associated with the source 208 and carrier 212 combination, the set of items are consolidated into a single container for shipping. The container is picked up by the carrier 212 from the source 208 for delivery to the delivery destination 202.

In this example, the mapping includes two sources and three carriers. However, the examples are not limited to two sources and three carriers. The mapping between possible sources and available carriers can include any number of sources and carriers. For example, the set of sources can include a single sources, as well as three or more sources. Likewise, the set of available carriers qualified to transport the set of items to the destination can include a single carrier, two carriers, as well as four or more carriers.

FIG. 3 is an exemplary block diagram illustrating a system 300 for optimizing PVS carriers. A user 302 provides carrier setup and configuration of carrier information by entering the carrier information into a user interface (UI) 304 for processing by the multichannel sourcing system (MCSE) 320 and storage in the database 308. In some examples, the carrier configuration is performed using information obtained from one or more carrier rate cards.

The database 308 is a data store for storing data, such as, but not limited to, carrier data 310 describing one or more carriers, inventory data 312 identifying items in inventory at one or more sources, and/or source data 314 describing one or more sources. In some examples, the database 308 is implemented as an Oracle® database.

A data feed processing system 316 in other examples processing live streaming data flowing from a database (DB) management system 318 and/or the MCSE 320. The data feed processing system 316 in some non-limiting examples can be implemented as an Apache Kafka® system.

In some examples, a customer 328 (user) creates a new order 330 via a user device 116 accessing an e-commerce source, such as a website 334. An order management system 332 facilitates order creation and forwards order data to the MCSE 320. The MCSE 320 analyzes inventory data 312, carrier data 310 and/or source data 314 to identify a carrier 322, source 324 and/or box method 326 providing a lowest shipping cost for shipping the ordered items from the source 324 to the customer's selected destination (pickup location or delivery address). The box method 326 determines whether the item(s) for order fulfillment are shipped as single piece or multi-piece packaging.

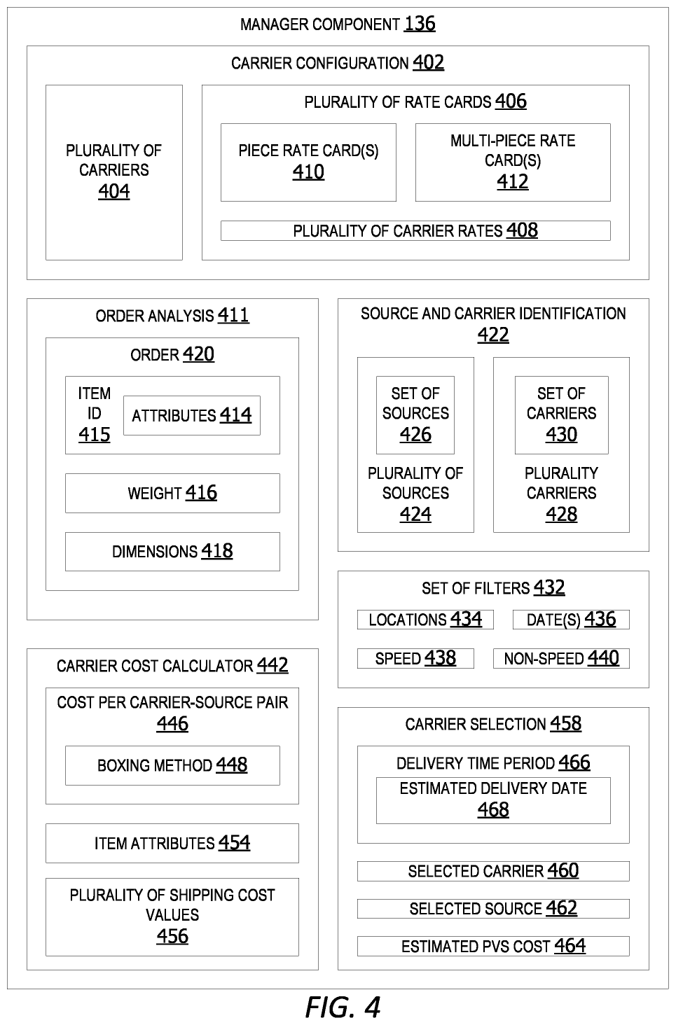

FIG. 4 is an exemplary block diagram illustrating a manager component 136. In some examples, the manager component 136 includes a carrier configuration 402 component. The carrier configuration 402 configures a plurality of carriers 404 for utilization in selecting a carrier for order fulfillment. The carrier configuration is performed using information from a plurality of rate cards 406 for each carrier in the plurality of carriers 404. The plurality of rate cards 406 includes a plurality of carrier rates 408. The plurality of rate cards 406 includes piece rate cards 410 and multi-piece rate cards 412.

In some examples, a rate card for a given carrier provides various rates for packages or other items based on the item identifier (ID) 415, dimensions 418, weight 416 of the item, and other attributes 414. An order analysis 411 component in some examples analyzes order 420 data to identify the item ID 415, attributes 414, weight 416 and/or dimensions 418.

The order information is utilized by the source and carrier identification 422 to identify a set of one or more sources 426 capable of providing the set of items for delivery. The order 420 information is utilized by the source and carrier identification 422 to identify a set of one or more carriers 430 from the plurality of carriers 428 available for picking up the set of items from at least one source and delivering the item(s) to the destination within the delivery time-period promised to the user.

In other examples, a set of filters 432 are applied to the plurality of sources 424 and/or the plurality of carriers 428 to identify the set of sources 426 and/or the set of carriers 430. In this example, the set of filters 432 include filters for eliminating sources based on date(s) for processing the items and/or locations 434 of the sources relative to the carriers and/or the destination. The set of filters 432 in other examples includes filters for filtering carriers from the plurality of carriers 428 based on speed 438 related factors and/or non-speed 440 related factors.

Speed related factors are factors which impact the speed with which one or more items are delivered by a carrier. A speed related filter can include a filter for identifying carriers which cannot deliver the items within the specified delivery timeframe.

A non-speed related filter can include filters for removing carriers which cannot satisfy service-level agreements unrelated to delivery times and dates. A non-speed related factor can include whether a carrier can deliver an item with sign-on delivery (SOD), whether a carrier can handle hazardous (hazmat) materials, whether the carrier vehicle is refrigerated or temperature controlled for delivery of temperature-sensitive items, etc.

A carrier cost calculator 442 is a software component for calculating cost per carrier-source pair 446 based on a boxing method 448. The boxing method 448 is determined based on rates for single piece v. multi-piece shipping rates. A box selection is made based on the boxing method and item attributes 454. The item attributes include factors, such as, but not limited to, the weight and dimensions of the items. The carrier cost calculator 442 generates a plurality of shipping cost values 456. In some examples, if there are five possible carriers and five possible sources, the source and carrier identification 422 identifies twenty-five possible source-carrier combinations. If each of the carriers provides both single piece and multi-piece shipping. In this example, the carrier cost calculator generates fifty shipping cost values representing each of the source-carrier pairs and boxing method combinations.

A carrier selection 458 software component identifies a selected carrier 460 and a selected source 462 which has the lowest estimated PVS cost 464. The selected carrier 460 and selected source 462 represented a lowest cost shipping option for delivery of ordered items to a destination by an estimated delivery date 468 within a delivery time-period 466.

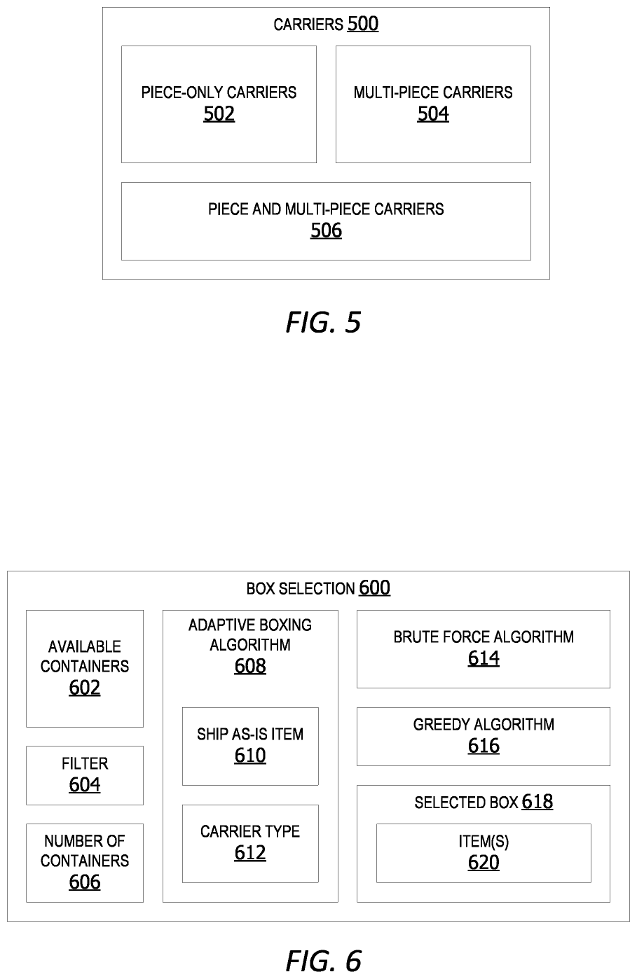

FIG. 5 is an exemplary block diagram illustrating PVS carriers 500. The carriers 500 includes piece only carriers 502 and multi-piece carriers 504. The carriers can also include both piece and multi-piece carriers 506. A piece and multi-piece carrier is a carrier providing both piece rate cards as well as multi-piece rate cards giving users the option to select which boxing method is preferable based on delivery speed and estimated shipping cost.

FIG. 6 is an exemplary block diagram illustrating a box selection 600 component for selecting a container for packaging an item for shipment. In some examples, the box selection 600 algorithm analyzes available containers 602 using a filter 604 to identify a selected box 618 in a number of containers for shipping one or more items, such as, but not limited to, the item(s) 620.

An adaptive boxing algorithm 608, in some examples, identifies a ship as-is item 610 and/or large bulk items, such as tires, which are shipped without boxing or otherwise packaging. These ship as-is items may have a label or tag attached to the item. However, these items are not packages, boxed, bagged, or otherwise placed into a container for shipping. The algorithm for determining whether to box an item for shipping or not may vary based on the carrier type 612. For example, a carrier capable of handling large freight items may prefer boxing of items which another carrier may prefer to remain unboxed for shipment.

A brute force algorithm 614 is applied in some examples to determine how many items to be placed into a given container and/or orientation of items within the container. A greedy algorithm 616 is applied in other examples to determine how to package one or more items. One or more boxing algorithms are utilized to identify a best fit box from a plurality of possible boxing options available for each source. Thus, if three different box sizes are available to package a given item, the boxing algorithm(s) are applied to identify which box is the best option for the item based on a variety of factors, including the item size, weight, other box sizes available, shipping costs, carrier capacity, etc.

In the above examples, a greedy algorithm or a brute force algorithm is described. However, any type of boxing algorithm may be used in other examples to determine how to box or otherwise package one or more items for shipment by a carrier. In other examples, best fit and/or first fit algorithms may be used. There is no specific change within the boxing algorithm but based on the type of carrier and accessorial charges being optimized. Any suitable boxing algorithm may be applied to determine optimized boxing in accordance with cost while excluding boxes (available box options for a given source) for which additional charges have to be paid. In other words, the system can utilize any boxing algorithm to assist with improving PVS output.

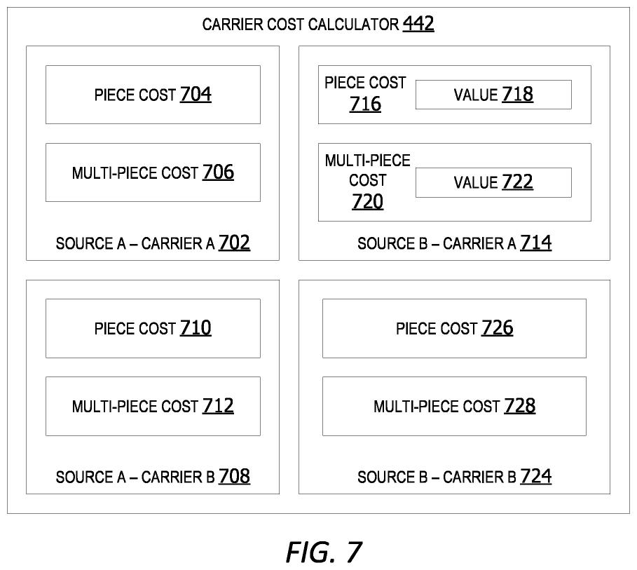

FIG. 7 is an exemplary block diagram illustrating a carrier cost calculator 442. The carrier cost calculator 442 calculates an estimated shipping cost for each source-carrier combination for one or more items in a given order. In this non-limiting example, the set of possible carriers includes two carriers, carrier A and carrier B. The set of sources includes a source A and a source B. For this set of two sources and two carriers, there are four possible source-carrier pairs. If each carrier includes both a piece and multi-piece option, there are a total of eight different source-carrier and boxing method combination.

The source A-carrier A 702 combination enables a cost estimate for the piece cost 704 and the multi-piece cost 706 for shipping the items from the source A to the destination. The source A-carrier B 708 combination includes a piece cost 710 and a multi-piece cost 712 for shipping the items. The source B-carrier A 714 includes a value 719 for the piece cost 716 estimate and a value 722 for the multi-piece cost 720. The source B-carrier B 724 is associated with a piece cost 726 and a multi-piece cost 728. The system analyzes each of the eight costs to identify the source-carrier pair and boxing method which optimizes both shipping cost and shipping speed.

FIG. 8 is an exemplary flow chart illustrating operation of the computing device to select a carrier and boxing method for shipping one or more items to a customer. The process shown in FIG. 8 is performed by a manager component, executing on a computing device, such as the computing device 102 or the user device 116 in FIG. 1.

The process begins by receiving order data at 802. The manager component analyzes carrier rates at 804. The manager component calculates a plurality of shipping cost values for shipping by the carriers at 806. A lowest shipping cost value is identified at 808. A carrier and boxing method is selected at 808. A notification is optionally provided at 812. The notification may be provided to a user device associated with a user at a selected source and/or a selected carrier for order fulfillment. A determination is made whether to continue at 814. If yes, the system iteratively executes operations 802 through 814 until a determination is made not to continue at 814. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

FIG. 9 is an exemplary flow chart illustrating operation of the computing device to optimize PVS carrier selection for shipping items from a source to a destination. The process shown in FIG. 9 is performed by a manager component, executing on a computing device, such as the computing device 102 or the user device 116 in FIG. 1.

The process begins by obtaining shipping information and customer delivery preferences, including promised delivery date at 902. The manager component identifies one or more carriers capable of delivering the items in accordance with the shipping information and preferences at 904. The manager component analyzes carrier rates based on delivery of each item in one or more boxes at 906. The manager component selects a carrier optimizing costs based on a single piece v. multi-piece packaging at 908. The manager component presents the promised delivery data to user with the selected carrier details at 910. The process terminates thereafter.

While the operations illustrated in FIG. 9 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 9.

FIG. 10 is an exemplary flow chart illustrating operation of the computing device for determining whether to pack an item in a box or without a box. The process shown in FIG. 10 is performed by a manager component, executing on a computing device, such as the computing device 102 or the user device 116 in FIG. 1.

The process begins by identifying an item having a flag for ship alone enabled and the item is marked SHIP ALONE at 1002. A determination is made whether to ship the item as-is at 1004. If yes, the item is prepared for ship alone boxing at 1006. The manager component gets a box list for a distributor at 1008. The distributor is a supplier of one or more of the items for delivery to the customer. The manager component determines if the carrier and boxing method is qualified at 1010. If the carrier and/or the boxing method is qualified based on the customer preferences and/or shipping requirements for the order at 1012, the manager component adds the item to acceptable boxes 1014. The manager component selects a box for the item from a list of carrier specific boxes at 1016. The item is packed in the selected box at 1018. The process terminates thereafter.

If the item is a ship as-is item at 1004, the item is packed without boxing at 1020. The process terminates thereafter.

Returning to 1012, if the carrier or the boxing method are not suitable, the box is rejected at 1022. The process terminates thereafter.

While the operations illustrated in FIG. 10 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 10.

FIG. 11 is an exemplary flow chart illustrating operation of the computing device to determine boxing for a hazmat item. The process shown in FIG. 11 is performed by a manager component, executing on a computing device, such as the computing device 102 or the user device 116 in FIG. 1.

The process begins by identifying a hazmat item with a flag for regular boxing set as false at 1102. The item is boxed for hazmat at 1104. The manager component gets a box list for the distributor at 1106. The manager component determines if the carrier and boxing method are acceptable at 1108. The carrier and boxing method are acceptable if they conform to the requirements for delivery of the item and satisfy the service-level agreement specifications. If yes, the item is added to acceptable boxes at 1112. A box for the item is selected from a list of carrier specific boxes at 1114. The process terminates thereafter.

While the operations illustrated in FIG. 11 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 11.

FIG. 12 is an exemplary flow chart illustrating operation of the computing device to determine boxing for a normal item. The process shown in FIG. 12 is performed by a manager component, executing on a computing device, such as the computing device 102 or the user device 116 in FIG. 1.

The process begins with boxing for normal items at 1202. The manager component gets a box list for a distributor at 1204. The manager component determines if the carrier is acceptable at 1206. If yes, the manager component adds the item to acceptable boxes at 1208 and identifies a box from a list of carrier specific boxes at 1210. A determination is made whether the box is empty at 1212. If yes, a determination is made whether the item count equals one at 1214. If no, the items are packed in the given boxes at 1216. The process terminates thereafter.

If the carrier is not acceptable at 1206, the box is rejected at 1218. The process terminates thereafter. If hard boxes is not empty at 1212, the item is packed without boxing at 1220. The process terminates thereafter.

While the operations illustrated in FIG. 12 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 12.

FIG. 13 is an exemplary flow chart illustrating operation of the computing device for determining boxing for multiple items. The process shown in FIG. 13 is performed by a manager component, executing on a computing device, such as the computing device 102 or the user device 116 in FIG. 1.

The process begins by identifying items to be packed in boxes at 1302. A determination is made whether the items are already packed in the same set of boxes at 1304. If yes, the previous results can be reused at 1316. If no, the manager component determines if hard boxes is not empty and box items at 1306. If no, the items can be bagged or the items may be mailer items at 1318. If the items are items to be placed in hard boxes, the manager component determines if there are two items to be boxed at 1308. If no, the manager component determines if the number of items equals one or exceeds a greedy threshold at 1320. If yes, a greedy algorithm is applied at 1322 for boxing items. If the greedy threshold is not exceeded, a brute force algorithm 1310 is applied. A result 1312 is obtained. The result specifies a type (size) and number of boxes (containers) for packing the item(s). The calculated box(es) is added to the packed boxes at 1314. The process terminates thereafter.

While the operations illustrated in FIG. 13 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 13.

FIG. 14 is an exemplary flow chart illustrating operation of the computing device for packing bag and mailer items. The process shown in FIG. 14 is performed by a manager component, executing on a computing device, such as the computing device 102 or the user device 116 in FIG. 1.

The process begins by identifying items for packing in a bag or as a mailer item at 1402. A determination is made whether the level of protection equals 2. The level of protection indicates a strength or thickness of a bag indicated for shipping based on the type, size, and/or weight of the item. If no, the item is packed in a polybag at 1406. If yes, the item is packed for a mailer items at 1408. A result from packing box items, mailer items and bag items is generated at 1410. For all items that could not be packed by boxing, the manager component indicates the items should be packed without boxing at 1412. The item is added to a packed box list at 1414. The packed box list is a list of items which have been boxed for shipping. The process terminates thereafter.

While the operations illustrated in FIG. 14 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 14.

FIG. 15 is an exemplary flow chart illustrating operation of the computing device for multi-piece carrier item boxing. The process shown in FIG. 15 is performed by a manager component, executing on a computing device, such as the computing device 102 or the user device 116 in FIG. 1.

The process begins by obtaining a packed box list at 1504. A determination is made whether a multi-piece carrier in the shipment at 1504. If yes, the manager component fetches the large package surcharge dimension for the carrier at 1506. For every box in the packed box list at 1508, the manager component determines if box dimensions exceed dimensions for applying a large package surcharge cost at 1510. If no, the packed box list becomes the final packed box list at 1512. The process terminates thereafter.

While the operations illustrated in FIG. 15 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 15.

FIG. 16 is an exemplary flow chart illustrating operation of the computing device to determine if a box is suitable for a given carrier. The process shown in FIG. 16 is performed by a manager component, executing on a computing device, such as the computing device 102 or the user device 116 in FIG. 1.

The process begins by getting a box list for distributor at 1602. A determination is made whether a carrier is suitable at 1604. The carrier is suitable if it can deliver the items within the delivery time-period and in accordance with user preferences and service-level agreement provisions. If yes, the item is added to the acceptable boxes at 1606. If no, the box is rejected at 1610. The item is added to a list of carrier specific boxes at 1608. The process terminates thereafter.

While the operations illustrated in FIG. 16 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 16.

In some non-limiting examples, the manager component fetches item data for a complete offer from a datastore, such as, but not limited to, the data storage device 120 in FIG. 1 and the database 308 in FIG. 3. The item data is used to create a sourcing context. The manager component fetches complete distributor from offer DC mapping and gets inventory for the ordered items. The manager component creates SLA based context and selects a fulfillment planner and invoke carrier optimization process.

The system, in other examples, fetches carrier method details from the data stores. The carrier method details can include, without limitation, carrier delivery areas, types of items transported by the carrier, dimension limits of packages, weight limits of packages, etc. The manager component also fetches preferred distributors, available boxes in the distributor and transit zone data for utilization during the carrier PVS optimization.

FIG. 17 is an exemplary flow chart illustrating operation of the computing device to perform PVS optimization for single item solution (SIS). The process shown in FIG. 17 is performed by a manager component, executing on a computing device, such as the computing device 102 or the user device 116 in FIG. 1.

The process begins by generating item based single item solution (SIS) at 1702. Service-level agreement (SLA) independent filters are applied at 1704. SLA dependent filters are applied at 1706. SLA independent filters filter carriers based on factors which are not set forth in the SLA. SLA independent filters can include factors such as, but not limited to, delivery location restrictions, hazardous items restrictions, delivery date limitations of the carrier, etc. SLA dependent filters are filtering carriers based on service-level agreement requirements, such as, but not limited to, SOD requirements, delivery date requirements, etc. The manager component calculates an estimated date of delivery (EDD) at 1708. The manager component applies SLA trimming at 1710. The manager component lists SLA bases SIS with date at 1712. The manager component gets zone charge for carriers at 1714. The manager component calculates costs for each source-carrier combination at 1716. The process is consolidated at 1718. The process terminates thereafter.

While the operations illustrated in FIG. 17 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 17.

FIG. 18 is an exemplary flow chart illustrating operation of the computing device to perform PVS optimization for multi-item solution. The process shown in FIG. 18 is performed by a manager component, executing on a computing device, such as the computing device 102 or the user device 116 in FIG. 1.

The process lists zip SLA base solver solution bucket at 1802. A list of multi-item solutions is generated at 1804. Bulk date calculator is performed at 1806. The date calculator bulk refers to determining estimated delivery dates for various source-carrier combinations where each source and carrier have varying capacity for delivering the items and differing estimated EDD. The manager component lists SLA multi-item solution with date at 1808. The manager component creates boxing for each list at 1810 and calculates fulfillment cost at 1812. The manager component lists SLA multi-item solution with date and cost at 1814. The best solution, with the lowest ship cost for a source-solution combination, is picked at 1816. The process terminates thereafter.

While the operations illustrated in FIG. 18 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 18.

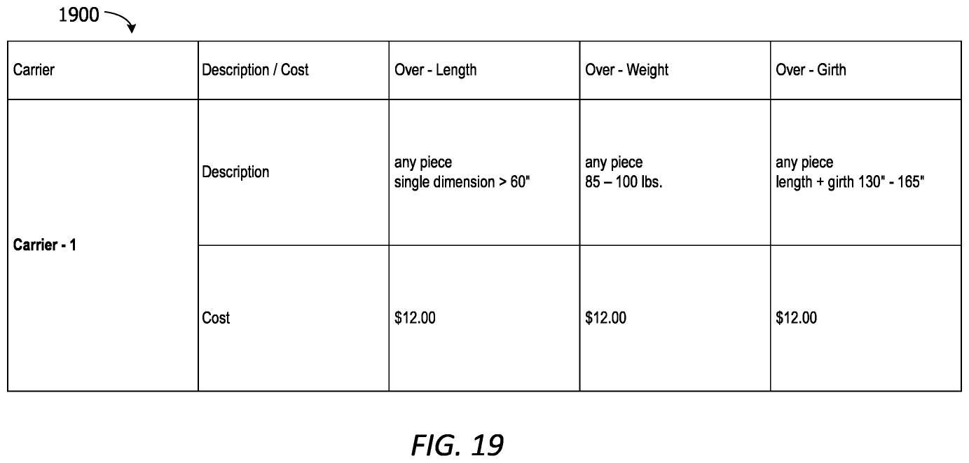

FIG. 19 is an exemplary table 1200 illustrating large package surcharge data. Apart from freight charges for shipping large items, like a refrigerator, a carrier can also charge a large package surcharge, also known as Accessorial charges. Large package surcharges are added, in some examples, if the box dimensions are beyond a certain threshold provided by the carrier.

A sample for large package surcharge for a carrier can be configured as shown in FIG. 19. This information is used in the boxing algorithm to avoid any large package type of accessorial charges for the shipment if possible.

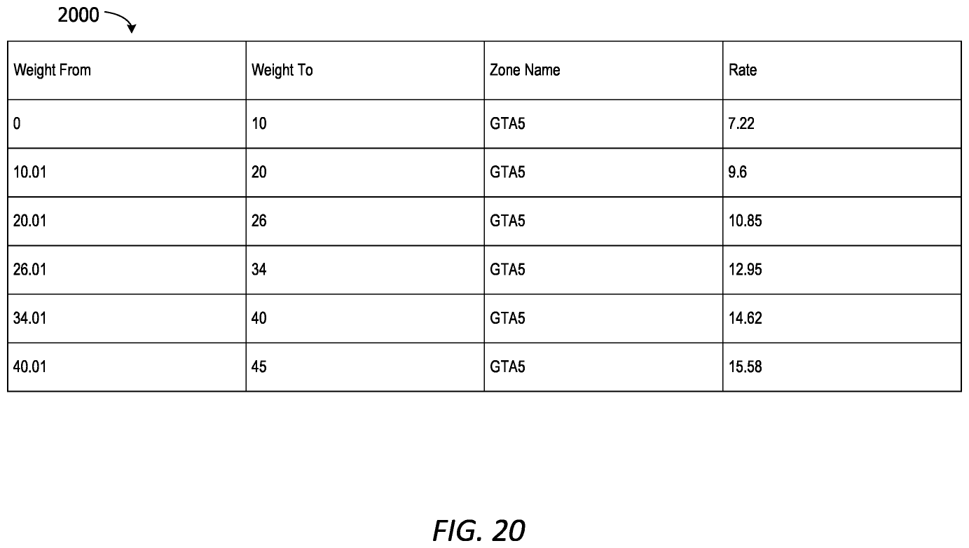

FIG. 20 is an exemplary block diagram illustrating a rate card 2000. Both the piece and multi-piece rate cards are similar, both can be setup in the same way. The rate card 2000 can includes information for shipping rates associated with weight of the item and shipping zones. The item weight in this example is in pounds (lbs.).

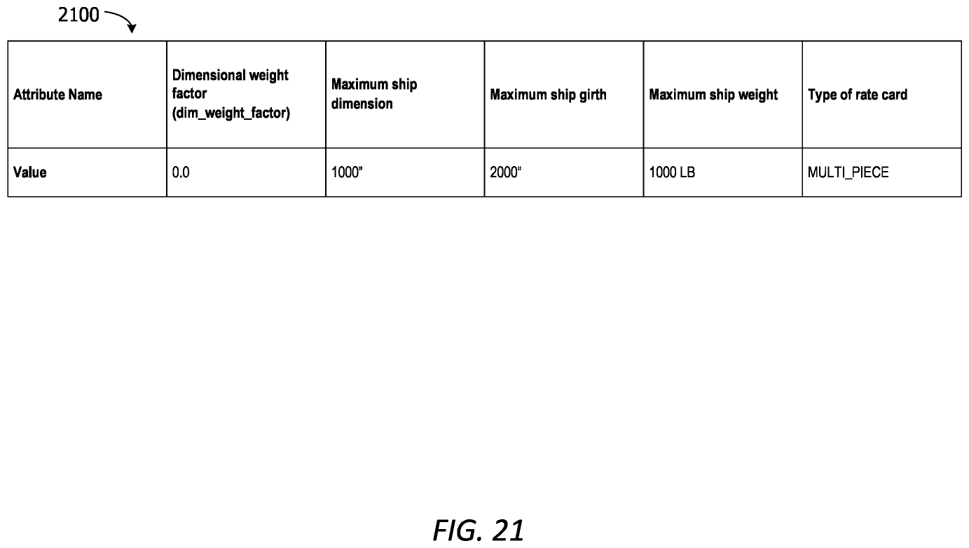

FIG. 21 is an exemplary block diagram illustrating a carrier logistic configuration rate card 2100. A rate card type can be configured as part of logistic configuration of the carrier. Along with the rate card type, other logistic configuration for carrier includes data such as, the maximum shipping weight, dimension, girth, and other upper limits to various dimensions supported by the carrier.

In some examples, the system provides the capability to configure different types of carriers, such as, single piece package carriers, multi-piece package carriers and carriers that support both singe piece and multi-piece carriers. Every carrier provides rate card for any source to destination, which is used to calculate the cost charged by the carrier. Transportation cost for a piece carrier is calculated based on box level rate card. Transportation cost for a multi-piece carriers is calculated using shipment level rate card. A carrier (any type) can provide the rate card which are based on the billable weight in the shipment. The formulae to calculate the billable weight per box is as follows:

$$\{ \begin{matrix}\frac{Volume of the box}{dim\_weigh \_factor} , & \begin{matrix}if volumetric weight is \\ enabledAnd \\ dim \_ weight \_ \\ factor >> 0\end{matrix} \\ Max \{ \begin{matrix}Actual Weight of the box \vert \\ Volume of the box / \\ dim\_weigh \_factor\end{matrix} \} , & else\end{matrix}$$

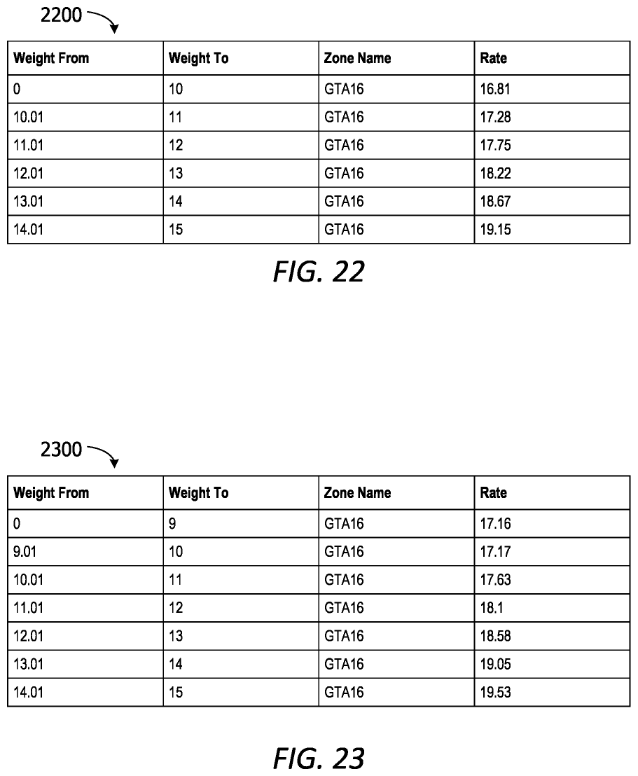

FIG. 22 is an exemplary block diagram illustrating a single-piece rate card 2200. A piece carrier only provides one or more piece rate cards, such as the single-piece rate card 2200.

FIG. 23 is an exemplary block diagram illustrating a multi-piece rate card 2300. A multi-piece carrier provides one or more multi-piece rate card. A carrier can also provide both type of rate cards.

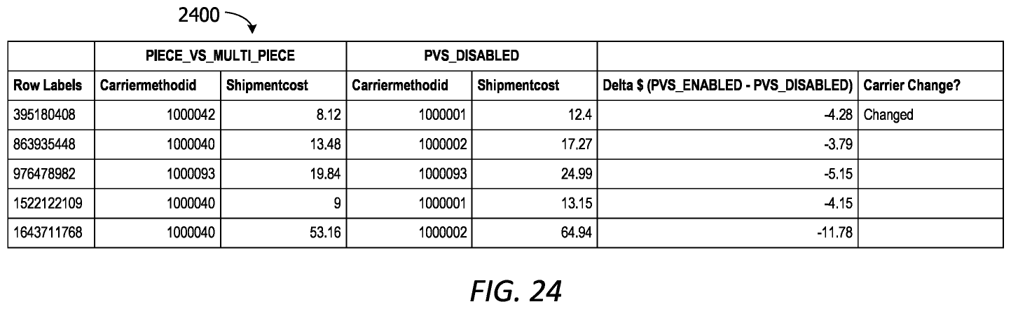

FIG. 24 is an exemplary table 2400 illustrating shipping cost savings as a result of PVS optimization. Optimizing shipping based on PVS enables significant savings and cost reduction in shipping costs for piece and multi-piece shipping of items, as shown in table 2400.

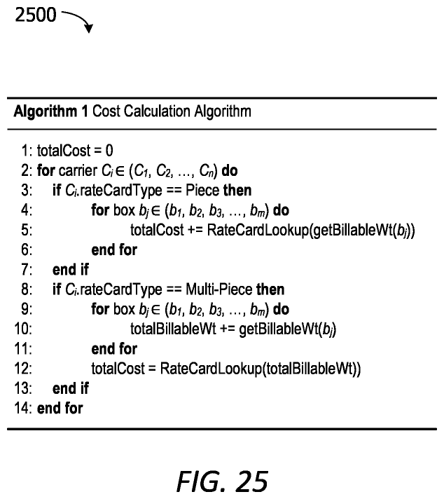

FIG. 25 is an exemplary cost calculation algorithm 2500. In one example, there are n carriers C1, C2, C3, . . . . ,Cn operating at a fulfillment center(FC) some of which are piece and some of them are multi-piece carriers. From this FC, a package with m boxes b1,b2,b, . . . ,bm having billable weights as w2,w2,w3, . . . ,wm is delivered. The pseudo code of the cost calculation algorithm 2500 illustrates the cost calculation for the various source-carrier combinations.

In some examples, the process begins when the customer places the order on the e-commerce site. If a given customer located at Point B, orders all the “p” number of items which are present at Fulfillment Center (Point A) and there are “q” carrier's which provide different rate cards, as well as type of rate cards (Piece/Multi-Piece/Both) and “r” number of boxes (containers) with variable size available at the FC. Given these variable, the system can select the carrier and combination of boxes to ship the order from Point A to Point B such that the transportation cost is cheapest in accordance with the algorithm 2500.

In another example if there are n boxes b1, b2, b3 . . . bn with their billable weights as w₁, w₂, w₃, . . . wₙ, then total freight cost to ship all the boxes is calculated using an algorithm in which the carrier's freight cost (F_{cost}) is calculated as follows:

$$\{ \begin{matrix}\begin{matrix}{\sum }_{i = 1}^{n} Freight cost of the \\ box billable wt . ( wi ) ,\end{matrix} & if CarrierType == PieceCarrier Type \\ Freight cost of {\sum }_{i = 1}^{n} wi , & if CarrierTypeis == Multi - Piece Type\end{matrix}$$

### Additional Examples

In some examples, the system allows a user to setup different types of carriers for PVS. Once the carrier is setup in the system, it is able to evaluate carrier selection in real-time. Each event(request) is handled independently. The system uses the resources without impacting/disturbing other events.

In other examples, the system uses dynamic cost calculation algorithm for each carrier based on the carrier type in real time. This cost calculation algorithm uses carrier type as input and provides cheapest cost by carrier, such as local optima. Among all the local optima (for every carrier) the global optima is evaluated based on cheapest cost (cheapest carrier).

In other examples, the system filters all the available boxes whose dimensions are beyond a threshold value, setup as the large package surcharge in logistic configuration of the carrier used in the boxing algorithm for multi-piece carrier. This ensures avoiding any accessorial charges for the shipment which might be charged by carrier and resulting in the cheaper cost.

The boxing logic enhancement, in other examples, is related to ship-as-is item and carrier type enables. The system utilizes a boxing algorithm along with other items in the order to ensure that we optimize the cost of the shipment for piece carrier and volume of the shipment for multi-piece carrier. In some examples, PVS and optimized boxing can save money, lessen wastage of packaging material, and cut down energy consumption of carrier to ship the boxes.

The invention, in other examples, provides optimization of package carrier/delivery in multi-channel sourcing with different types of rate cards (piece, multi-piece or both) which enables significant savings in transportation cost. The system provides optimization in boxing which enhances carrier selection and improves savings. The process obtain/determine shipping information and/or customer delivery preferences, including promised delivery date, estimated time of delivery (EDO), delivery or pickup, sign on delivery (SOD), number of items to delivery, item dimensions, etc. The system identifies carriers capable of delivery in accordance with the shipping information, customer preferences, estimated ship date, estimated delivery date, source (distribution center locations) having the ordered items available and destination (ship to customer home or store for pickup). The carriers available vary based on geographic regions, carrier limitation, etc.

In still other examples, the system analyzes carrier rates based on delivery of each item in a separate, smaller box vs. rates for packing multiple items into one or more larger box containing multiple items (multi-piece). A carrier is selected for order fulfillment optimizing costs for single piece versus multi-piece packaging based on box weights, box volume, rate cards, transit times, etc. In some cases, it is cheaper to ship items from a source (point A) to a destination (point B) as multiple, smaller packages rather than in a larger, bulkier (higher volume) package. MCSE provides promised delivery dates to customers and provides selected carrier details for order fulfillment.

In an example scenario, the manager component is part of a sourcing engine which knows about the entire network, supply chain logic and business rules. The process begins when a user selects items to order via an e-commerce website or application. A predicted delivery date for each item is offered with each item selection. If the user orders three items, the system identifies all possible sources for the three ordered items. The possible sources include sources for all three of the items, sources having two of the items, as well as source which only have available one of the three items. If all three items are present at a thousand miles away from the customer (destination) at one warehouse (fulfillment center), the first item is available from a source at a store in the same town as the destination, the second item is present five hundred miles in an Eastern direction at another store from the customer, and a third item is present at three hundred miles West at another DSV center. In this scenario, the system chooses the fulfillment center having all three items available at a single source, even though the warehouse is farther away than the other source options. In this manner, the system prioritizes consolidating items at the fewest number of sources for shipping to the destination. Once a source has been chosen, the system applies the boxing algorithm(s) and algorithms for identifying a carrier to ship the items from the selected source, container sizes for packaging the items, and number of items to place in each container for shipping which will minimize the shipping costs while ensuring delivery to the customer within the promised delivery time span.

Alternatively, or in addition to the other examples described herein, examples include any combination of the following:
receiving, from a user device, order data comprising an identification of a set of items, a delivery destination, and a delivery time-period;
analyzing, by a manager component, a plurality of carrier rates obtained from a plurality of rate cards associated with a plurality of carriers available for delivery of the set of items from at least one source location to the delivery destination;
providing, via a network, a notification to the user device identifying the selected carrier and the number of containers selected to ship the set of items to the delivery destination within the delivery time-period.
configuring carrier data associated with the plurality of carriers within a database for delivery of items from a plurality of sources, the plurality of carriers comprising single piece carriers and multi-piece carrier;
assigning the selected carrier to ship the set of items from the selected source to the delivery destination;
applying a cost-based boxing algorithm to optimize item packaging and avoid accessorial charges;
applying a greedy algorithm for selecting a boxing method for a selected item;
applying a brute force algorithm for selecting a boxing method for a selected item;
selecting a carrier for order fulfillment based on the additional factors, including box weights, box volume, rate cards, transit times, and estimated delivery date;
providing, via a network, a notification to a user interface device identifying the selected carrier and the number of containers selected to ship the set of items to the delivery destination within the delivery time-period; and
applying a boxing algorithm for selecting a container and a container size from a plurality of available containers and container sizes associated with a source of at least one item in the set of items.

At least a portion of the functionality of the various elements in FIG. 1, FIG. 2, FIG. 3, FIG. 4, FIG. 5, FIG. 6, and FIG. 7 can be performed by other elements in FIG. 1, FIG. 2, FIG. 3, FIG. 4, FIG. 5, FIG. 6 and FIG. 7, or an entity (e.g., processor 106, web service, server, application program, computing device, etc.) not shown in FIG. 1, FIG. 2, FIG. 3, FIG. 4, FIG. 5, FIG. 6, and FIG. 7.

In some examples, the operations illustrated in FIG. 8, FIG. 9, FIG. 10, FIG. 11, FIG. 12, FIG. 13, FIG. 14, FIG. 15, FIG. 16, FIG. 17, and FIG. 18 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of PVS carrier optimization, the method comprising receiving, from a user device, order data comprising an identification of a set of items, a delivery destination and a delivery time-period; analyzing, by a manager component, a plurality of carrier rates obtained from a plurality of rate cards associated with a plurality of carriers available for delivery of the set of items from at least one source location to the delivery destination, the plurality of rate cards comprising a set of single piece rate cards describing rates for shipping the set of items in a single container and a set of multi-piece rate cards describing rates for shipping the set of items in two or more separate containers; calculating a plurality of shipping cost values based on the plurality of carrier rates and item data associated with the set of items, the item data comprising item weight and item dimensions for each item in the set of items; identifying a lowest shipping cost value in the plurality of shipping cost values, wherein each value in the plurality of shipping cost values corresponding to a calculated cost for shipping the set of items packaged according to a selected boxing method for delivery to the delivery destination from a selected source by a selected carrier in the plurality of carriers, wherein the plurality of shipping cost values includes at least one shipping cost value for each carrier-source pair; and selecting a carrier from the plurality of carriers and the boxing method corresponding to a lowest shipping cost value in the plurality of shipping cost values, the boxing method specifying a number of containers into which the set of items are packaged for shipping. The boxing method includes a single-piece or a multi-piece boxing method.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data collected from the users. In some examples, notice is provided to the users of the collection of the data (e.g., via a dialog box or preference setting) and users are given the opportunity to give or deny consent for the collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for PVS carrier optimization. For example, the elements illustrated in FIG. 1, FIG. 2, FIG. 3, FIG. 4, FIG. 5, FIG. 6 and FIG. 7, such as when encoded to perform the operations illustrated in FIG. 8, FIG. 9, FIG. 10, FIG. 11, FIG. 12, FIG. 13, FIG. 14, FIG. 15, FIG. 16, FIG. 17 and FIG. 18, constitute exemplary means for receiving order data comprising an identification of a set of items, a delivery destination and a delivery time-period; exemplary means for analyzing a plurality of carrier rates obtained from a plurality of rate cards associated with a plurality of carriers available for delivery of the set of items from at least one source location to the delivery destination; exemplary means for calculating a plurality of shipping cost values based on the plurality of carrier rates and item data associated with the set of items, the item data comprising item weight and item dimensions for each item in the set of items; exemplary means for identifying a lowest shipping cost value in the plurality of shipping cost values; exemplary means for selecting a carrier from the plurality of carriers and the boxing method corresponding to a lowest shipping cost value in the plurality of shipping cost values; exemplary means for providing a notification to the user device identifying the selected carrier and the number of containers selected to ship the set of items to the delivery destination within the delivery time-period.

In some examples, the notification may be provided to a user device associated with a user at a selected source and/or a user at a selected carrier for order fulfillment. The notification can include instructions for preparing the ordered items for pickup by a carrier. This can include boxing/packaging. The notification can also include instructions to a carrier instructing the user when and/or where to pick up packaged items for delivery to the customer at a delivery destination.

Other non-limiting examples provide one or more computer storage devices having a first computer-executable instructions stored thereon for providing optimized PVS carrier selection and boxing method. When executed by a computer, the computer performs operations including obtaining, via a network, a plurality of carrier rates from a plurality of rate cards associated with a plurality of carriers available for delivery of a set of items from at least one source location to a delivery destination; calculating a plurality of shipping cost values based on the plurality of carrier rates and item data associated with the set of items, the item data comprising item weight and item dimensions for each item in the set of items; identifying a lowest shipping cost value in the plurality of shipping cost values; and selecting a carrier from the plurality of carriers and the boxing method corresponding to the lowest shipping cost value.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a memory; and
at least one processor communicatively coupled to the memory;
analyze a plurality of carrier rates obtained from a plurality of rate cards associated with a plurality of carriers available for delivery of a set of items from at least one source location to a delivery destination, the plurality of rate cards comprising a set of single piece rate cards describing rates for shipping the set of items in a single container and a set of multi-piece rate cards describing rates for shipping the set of items in two or more separate containers;
calculate a plurality of shipping cost values based on the plurality of carrier rates and item data associated with the set of items, the item data comprising item weight and item dimensions for each item in the set of items, each value in the plurality of shipping cost values corresponding to a calculated cost for shipping the set of items packaged according to a boxing method for delivery to the delivery destination from a selected source by a selected carrier in the plurality of carriers, wherein the plurality of shipping cost values includes at least one shipping cost value for each carrier-source pair; and
select a carrier from the plurality of carriers and the boxing method corresponding to a lowest shipping cost value in the plurality of shipping cost values, the boxing method specifying a number of containers into which the set of items are packaged for shipping, the boxing method comprising a single-piece packaging or a multi-piece boxing packaging.

2. The system of claim 1, further comprising:
provide, via a network, a notification to a user device identifying the selected carrier and the number of containers selected to ship the set of items to the delivery destination within a delivery time-period, the user device associated with a selected source from a plurality of sources.

3. The system of claim 1, further comprising:
configure carrier data associated with the plurality of carriers within a database for delivery of items from a plurality of sources, the plurality of carriers comprising single piece carriers and multi-piece carrier.

4. The system of claim 1, further comprising:
assign the selected carrier to transport the set of items from the selected source to the delivery destination.

5. The system of claim 1, further comprising:
a user interface device displaying the selected carrier and the number of containers selected to ship the set of items to the delivery destination within a delivery time-period.

6. The system of claim 1, further comprising:
a boxing algorithm for selecting a container and a container size from a plurality of available containers and container sizes associated with a source of at least one item in the set of items.

7. The system of claim 1, further comprising:
a selected carrier for order fulfillment, the selected carrier selected based on additional factors, including box weights, box volume, rate cards, transit times, and estimated delivery date.

8. A computer-implemented method comprising:
calculating a plurality of shipping cost values for a plurality of carriers available to deliver a set of items from at least one source location to a delivery destination based on a plurality of carrier rates obtained from a plurality of rate cards associated with the plurality of carriers and item data associated with the set of items, the item data comprising item weight and item dimensions for each item in the set of items, the plurality of rate cards comprising a set of single piece rate cards describing rates for shipping the set of items in a single container and a set of multi-piece rate cards describing rates for shipping the set of items in two or more separate containers;
identifying a lowest shipping cost value in the plurality of shipping cost values, wherein each value in the plurality of shipping cost values corresponding to a calculated cost for shipping the set of items packaged to the delivery destination from a selected source by a selected carrier in the plurality of carriers, wherein the plurality of shipping cost values includes at least one shipping cost value for each carrier-source pair;
selecting a carrier from the plurality of carriers corresponding to a lowest shipping cost value in the plurality of shipping cost values;
selecting a boxing method specifying a number of containers into which the set of items are packaged for shipping, the boxing method comprising a single-piece packaging or a multi-piece packaging; and
assigning the selected carrier to transport the set of items from the selected source to the delivery destination.

9. The computer-implemented method of claim 8, further comprising:
configuring carrier data associated with the plurality of carriers within a database for delivery of items from a plurality of sources, the plurality of carriers comprising single piece carriers and multi-piece carrier.

10. The computer-implemented method of claim 8, further comprising:
assigning the selected carrier to ship the set of items from the selected source to the delivery destination.

11. The computer-implemented method of claim 8, further comprising:
applying a cost-based boxing algorithm to optimize item packaging and avoid accessorial charges.

12. The computer-implemented method of claim 8, further comprising:
providing, via a network, a notification to a user interface device identifying the selected carrier and the number of containers selected to ship the set of items to the delivery destination within a delivery time-period.

13. The computer-implemented method of claim 8, further comprising:
applying a boxing algorithm for selecting a container and a container size from a plurality of available containers and container sizes associated with a source of at least one item in the set of items.

14. The computer-implemented method of claim 8, further comprising:
selecting a carrier for order fulfillment based on additional factors, including box weights, box volume, rate cards, transit times, and estimated delivery date.

15. One or more computer storage media, having computer-executable instructions that, when executed by a computer cause the computer to perform operations comprising:
calculating a plurality of shipping cost values based on a plurality of carrier rates obtained from a plurality of rate cards associated with a plurality of carriers available for delivery of a set of items from at least one source location to a delivery destination and item data associated with the set of items, the item data comprising item weight and item dimensions for each item in the set of items, the plurality of rate cards comprising a set of single piece rate cards describing rates for shipping the set of items in a single container and a set of multi-piece rate cards describing rates for shipping the set of items in two or more separate containers;
identifying a lowest shipping cost value in the plurality of shipping cost values, wherein each value in the plurality of shipping cost values corresponding to a calculated cost for shipping the set of items packaged according to a boxing method for delivery to the delivery destination from a selected source by a selected carrier in the plurality of carriers, wherein the plurality of shipping cost values includes at least one shipping cost value for each carrier-source pair;
selecting a carrier from the plurality of carriers and the boxing method corresponding to the lowest shipping cost value, the boxing method specifying a number of containers into which the set of items are packaged for shipping, the boxing method comprising a single-piece packaging or a multi-piece packaging, wherein the selected carrier delivers the set of items packaged in the number of containers to the delivery destination; and
assigning the selected carrier to transport the set of items from the selected source to the delivery destination.

16. The one or more computer storage media of claim 15, wherein the computer-executable instructions are further executed by the computer to cause the computer to perform additional operations comprising:
configuring carrier data associated with the plurality of carriers within a database for delivery of items from a plurality of sources, the plurality of carriers comprising single piece carriers and multi-piece carrier.

17. The one or more computer storage media of claim 15, wherein the computer-executable instructions are further executed by the computer to cause the computer to perform additional operations comprising:
receiving, from a user device, order data comprising an identification of the set of items, the delivery destination, and a delivery time-period.

18. The one or more computer storage media of claim 15, wherein the computer-executable instructions are further executed by the computer to cause the computer to perform additional operations comprising:
assigning the selected carrier to ship a set of items from the selected source to the delivery destination.

19. The one or more computer storage media of claim 15, wherein the computer-executable instructions are further executed by the computer to cause the computer to perform additional operations comprising:
providing, via a network, a notification to a user device identifying the selected carrier and the number of containers selected to ship the set of items to the delivery destination within a delivery time-period.

20. The one or more computer storage media of claim 15, wherein the computer-executable instructions are further executed by the computer to cause the computer to perform additional operations comprising:
applying a cost-based boxing algorithm to optimize item packaging and avoid accessorial charges.
